(19) United States
(12) Patent Application Publication
(10) Pub. No.: US 2008/0263660 A1
(43) Pub. Date: Oct. 23, 2008

(54) Method, Device and Program for Detection of Address Spoofing in a Wireless Network

(75) Inventors: Roland Duffau, Paris (FR); Jerome Razniewski, Issy Les Moulineaux (FR); Laurent Butti, Issy Les Moulineaux (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/884,603

(22) PCT Filed: Feb. 15, 2006
(86) PCT No.: PCT/FR06/00353

§ 371 Date: Aug. 17, 2007

(30) Foreign Application Priority Data
Feb. 18, 2005 (FR) 0501703

(51) Int. Cl. G06F 21/00

(52) U.S. Cl. 726/22

(57) ABSTRACT

The invention relates to a method, device and program for detection of address spoofing in a wireless network. According to the invention, a sensor is installed in order to capture frames transmitted over the wireless network which have an address field comprising an address of a network access point. The captured frames are analyzed in order to establish a list of stations that are associated with the access point. Another list of stations associated with the access point is obtained from the latter. The two station lists are compared in order to detect possible access point address spoofing.

The present invention relates to the technologies for wireless access to telecommunication networks. It applies in particular to the IEEE 802.11 type technologies standardized by the Institute of Electrical and Electronics Engineers (IEEE). The IEEE 802.11 technologies are widely used in enterprise and home networks as well as in heavy usage areas (hot spots). More particularly, the invention relates to wireless network piracy by access point address spoofing.

The term “frame” is used here to mean a data set forming a block transmitted in a network and containing useful data and service information, normally located in a header area of the block. Depending on the context, a frame may be qualified as a data packet, a datagram, a data block, or another expression of this type.

With the success and the democratization of the wireless access technologies, piracy and attack techniques have emerged.

Currently, one of the greatest risks for this type of network is attack by illegal access point, which consists in creating a false access point by completely usurping (spoofing) the characteristics, in particular the MAC (Medium Access Control) layer address, of a legitimate access point, controlled by the wireless network administrator. The false access points that do not spoof an MAC address of a legitimate access point are relatively easy to detect by simple MAC address verification.

The access point is a vital element in communication between a client and a network. Because of this, it is a critical point, and therefore of interest to the attackers. Attacks based on false access points have emerged with the following objectives:
to recover connection identifiers for users who are authenticated by means of “captive portals” by passing themselves off as a legitimate access point in order to intercept identification data such as connection identifiers;
to intercept communications by performing a “man in the middle” type attack, that is, by simulating the behavior of a legitimate access point with respect to the wireless user and that of a wireless user with respect to the legitimate access point in order to intercept all communications; and
to open up an entire enterprise network by leaving an access point directly connected to the enterprise network in open mode, that is, with no authentication or encryption of the radio channel, this access point by default accepting any connection request.

These attacks are difficult to detect when they implement an MAC address spoofing technique. It is then more difficult to distinguish two different devices of the same category sending from one and the same MAC address. The advent of the new, more secure standards (IEEE 802.11i) will not prevent the use of illegitimate access points because the interest for the attacker will still remain.

There is therefore a need for a method of detecting access point MAC address spoofing.

One known technique for detecting MAC address spoofing is based on analyzing the sequence number field of the IEEE 802.11 frames. These sequence numbers, managed at low level in the radio card, are mandatorily incremented by one unit in each frame sent. This makes it possible to identify significant variations between multiple successive frames sent by one and the same MAC address. By comparing these variations with predefined thresholds, it is possible to detect anomalies in the frames appearing from an MAC address, and deduce from this the probable spoofing of this address by an attacker.

This technique entails managing thresholds that are very precise and difficult to set. It is difficult to implement on its own and to ensure the absence of false positives (false alarms) and false negatives (undetected attacks). The main difficulty lies in the management of the frame losses, for example in a long distance transmission. In practice, some frames are then lost, which results in false positive problems because the sequence numbers vary widely from one frame to another. It is necessary to manage the detection thresholds very finely. This is why this technique is often inadequate and must be combined with one or more other techniques in order to correlate the alarms and so have a greater confidence in the alarms that have been raised.

One aim of the present invention is to propose a novel method of detecting address spoofing in a wireless network of IEEE 802.11 or similar type.

The invention thus proposes a method of detecting address spoofing in a wireless network, comprising the following steps:
capturing frames transmitted over the wireless network, having an address field that comprises an address of a network access point;
analyzing the captured frames to establish a first list of stations associated with said access point;
obtaining from said access point a second list of stations that are associated with it; and
comparing the first and second lists of stations.

The method is based on cross-checking information collected by sensors that capture the frames transmitted over the wireless network and by legitimate access points controlled by the network administrator. If an illegitimate access point succeeds in spoofing the MAC address of a legitimate access point and in having it associated with one or more wireless stations in its place, this legitimate access point will not normally consider these stations to be associated with it.

By searching for the stations in the first list, received from a sensor, that are missing in the second list received from the access point, it is then possible to detect the presence of an illegitimate access point spoofing the MAC address of a legitimate access point. An alarm can thus be triggered if the first list includes at least one station that is absent from the second list. To avoid certain false alarm cases, provision can be made for the obtaining and comparing of the first and second lists to be repeated regularly, and for an alarm to be triggered if P consecutive comparisons show that the first list includes at least one station that is absent from the second list, P being a number greater than or equal to two.

To reinforce the probability of detection, it is possible to deploy multiple sensors in the coverage area of the wireless network, to capture the frames and establish the first lists relating to at least one access point. Each established first list is then compared to the second list obtained from the legitimate access point to detect any address spoofing in the network.

Another aspect of the invention relates to a device for detecting address spoofing in a wireless network for implementing the above method. This device comprises:
means for receiving from at least one sensor identification information originating from frames captured by said sensor on the wireless network, the captured frames having an address field that comprises an address of a network access point, said received identification information corresponding to a first list of stations associated with said access point;
means for obtaining from said access point a second list of stations associated with said access point; and
means for comparing the first and second lists of stations.

The received identification information can comprise the first list, or even be used to construct the first list.

In the first case, the first list is established directly by the sensor before being transmitted to the device for detecting address spoofing. The sensor is arranged to establish the first list itself.

In the second case, the first list can be established by the device for detecting address spoofing, from the identification information received from the sensor. The device then comprises means of analyzing the identification information to establish the first list.

The expression “identification information” therefore denotes both the first list itself and information that can be used to establish this first list, for example the source and destination fields of the captured frames.

The invention also proposes a system for detecting address spoofing in a wireless network comprising the above device and a sensor arranged to recommence at zero establishing new identification information relating to the stations associated with the access point, after having transmitted the preceding identification information. Each set sent by the sensor after a time interval Δt is therefore representative of the network activity observed during this time interval only.

The invention also proposes a computer program to be installed in a device interfaced with at least one access point of a wireless network and with a sensor to help in detecting address spoofing in the wireless network, to be run by a processing unit of this device. This program comprises instructions for executing the following steps when the program is run by the processing unit: receiving from the sensor identification information originating from frames captured by the sensor on the wireless network, the captured frames having an address field that comprises an address of the access point, the identification information corresponding to a first list of stations associated with the access point; obtaining from said access point a second list of stations that are associated with it; and comparing the first and second lists of stations.

Other particular features and advantages of the present invention will become apparent from the description below of exemplary but nonlimiting embodiments, with reference to the appended drawings, in which:

FIG. 1 is a block diagram of a wireless network in which the invention is implemented;

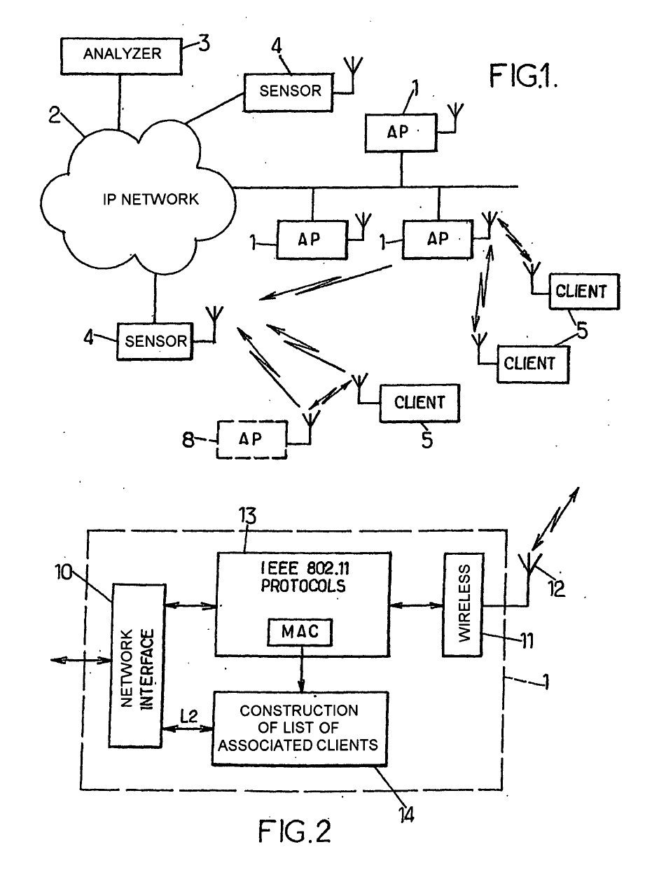

FIG. 2 is a block diagram of an access point of this network, for which attempts are being made to detect a possible address spoofing;

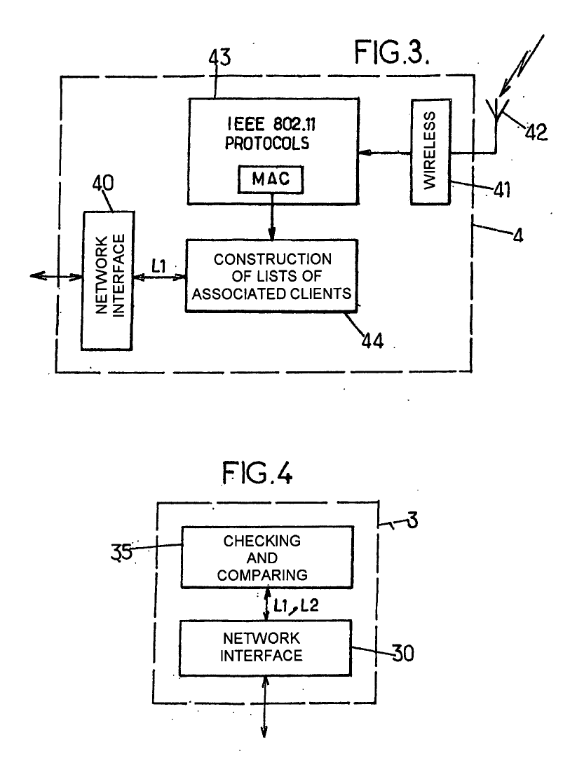

FIG. 3 is a block diagram of an exemplary sensor intended for a system for detecting address spoofing according to one embodiment of the invention; and

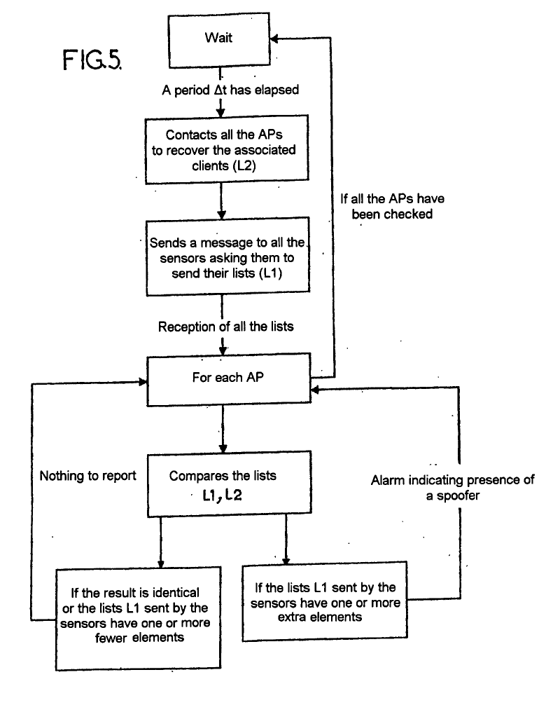

FIG. 4 is a block diagram of an exemplary detection device according to the invention; and

FIG. 5 is a flow diagram of a program that can be run in the device of FIG. 4.

The invention is described below in its particular application to the detection of MAC address spoofing in an IEEE 802.11-type wireless network.

The well-known method of associating an IEEE 802.11 client with an access point (AP) is as follows. In an access point discovery phase, the client station listens to the radio channel to look for specific frames called beacons. The client examines the information contained in this type of frame, in particular the network name (SSID, “Service Set Identifier”) and the parameters specific to the network deployed. Then, the client sends access point search (sensor request) frames containing the network name (SSID) being sought. The access point or points concerned respond to the request by returning a “sensor response” frame indicating their presence. Depending on the elements discovered in this way, the client selects the required access point and asks to be authenticated with it. If the authentication is successful, the client asks to be associated with the access point. If the association is successful, the client can send and receive data via the access point to which he is connected.

When using an illegitimate access point on the radio channel, the attacker normally uses a technique for completely spoofing the access point: same network name (SSID), same MAC address. However, it does not normally use the same radio channel for reasons of radio interference.

The IEEE 802.11 network diagrammatically represented in FIG. 1 comprises a certain number of access points 1 distributed over the network's coverage area. In the example represented, these access points are linked to an IP type network 2 which can be the Internet. To implement the invention, two other modules 3, 4 are linked to the access points 1 either directly, or via the IP network 2, namely a detection device, or analyzer, 3 which supervises the detection process and carries out the list comparisons on which the detection is based, and one or more sensors 4 that are deployed so as to be within radio range of the access points 1 or of the client stations 5 that communicate with them.

FIG. 2 diagrammatically shows the component elements of a legitimate access point 1 of the wireless network. Circuits 10 provide the interface with the wired part of the network, whereas the radio circuits 11 cooperating with the antenna 12 of the access point are responsible for sending and receiving the signals over the wireless interface. Between these interface circuits 10, 11, the protocols of the IEEE 802.11 standard, in particular the MAC protocol, enable the client stations 5 to access the wireless network in a manner known per se.

These protocols are typically implemented by having appropriate programs run by a processor 13 or logic circuits of the access point 1. To implement the invention, these programs also comprise a software module 14 which constructs and updates the list of clients 5 that are associated with the access point 1. This list, denoted L2, contains the MAC addresses of all the clients 5 that are associated with the access point 1 at the time concerned. It is established according to associations and disassociations of clients observed by the MAC layer of the access point. This list L2 is transmitted to the analyzer 3 via the network 2, either at the request of the analyzer 3 or spontaneously, periodically.

Each sensor 4 (FIG. 3) is a passive listening device on the radio channel. It comprises circuits 40 for the interface with the wired part of the network and radio circuits 41 for applying the reception processes to the signals captured by the antenna 42 of the sensor. The sensor 4 also comprises a processor 43 which executes programs implementing the reception part of the IEEE 802.11 protocols, in particular the MAC protocol.

In particular, the MAC layer of the sensor 4 examines the source address, destination address and frame type fields that are contained in the frames captured by the antenna 42.

The processor 43 also runs a software module 44 which, in a first variant of the invention, constructs lists of clients respectively associated with a certain number of access points 1. These access points are those whose MAC address is observed in the source and/or destination address fields of the captured frames. The other address field of the captured frame can be used to identify the client that sent it or to which it is addressed.

In a second variant of the invention, not shown, the software module transmits to the analyzer identification information relating to the clients associated with the access point. The analyzer establishes the list of clients associated with the access point from the received identification information.

The lists of associated clients, denoted L1, are constructed for different access point addresses over a predefined duration Δt which is, for example, of the order of a few minutes. This duration Δt can be specified by the analyzer 3, which can, in particular, adjust it according to the number of associations observed or spoofing detection statistics.

To determine the clients 5 associated with an access point 1, a sensor 4 can, for example, use one of the following methods (the list is not exhaustive):
each time an “association success” type frame is identified originating from an access point 1 (that is, having as its source MAC address the BSSID (Basic Service Set Identifier) of a device already identified as being an access point), the module 44 of the sensor adds, to the list L1 corresponding to this access point 1, the destination MAC address found in this frame, if said address is not already present in the list L1; and/or
the captured IEEE 802.11 data frames originating from a device identified as being an access point are examined by the module 44 of the sensor which adds, to the list L1 corresponding to this access point, the destination MAC address found in these frames, if said address is not already present in the list L1.

To optimize the latter identification method, bearing in mind in particular that the data frames can be spoofed by an attacker, a threshold can be used, defined as being the minimum number N of frames of this type that the sensor must capture to confirm the fact that the client 5 having the address concerned is indeed associated with the access point 1. For example, the identification of a client in the list L1 can be confirmed only when the sensor 4 has observed at least a hundred data frames sent by the access point 1 for its attention (N=100).

Also, the sensor 4 also determines when a client 5 disconnects from an access point 1, and deletes the address of this client from the corresponding list L1. For this, it can, for example, detect the “disassociation” or “disauthentication” requests to the MAC address of a device identified as being an access point. It then deletes from the corresponding list the source MAC address of that request, which corresponds to the client which is disconnected.

When a sensor 4 has sent its list L1 to the analyzer 3, it recommences from zero the process of creating a new list. Each list sent by a sensor after a time interval Δt is therefore representative of the network activity observed during this time interval only. Thus, if a client was disassociated from a legitimate access point during the preceding interval Δt, and if the sensor was not able to observe this disassociation because of a loss of packets, this client will not be added to the list created during the next interval Δt. The detection of false positives is thus limited.

FIG. 4 diagrammatically shows the construction of an analyzer device 3 which supervises the spoofing detection process and triggers alarms in case of detection, in order for the wireless network administrator to be able to take the appropriate measures.

The analyzer 3 comprises circuits 30 for the interface with the wired part of the network and a processor 35 which uses appropriate programs to carry out the checking and comparison operations that make it possible to detect address spoofing instances.

Via the interface 30, the processor 35 periodically, with a periodicity of Δt, recovers the lists L1, L2 established by the sensors 4 and the access points 1. The lists L1, L2 can be sent spontaneously by the sensors 4 and/or the access points 1 with the periodicity Δt, or in response to a request from the analyzer 3.

To contact the access points 1 and recover the lists L2 of clients 5 that are associated with them, the analyzer 3 uses, for example, mechanisms present in the access point type devices, by a protocol such as SNMP (Simple Network Management Protocol).

It is advantageous for the sending of the lists by the access points and the sensors to be synchronized, to minimize the probability that the lists L1, L2 show differences that are not linked to the presence of a spoofer.

The process of comparing two lists L1, L2 concerning one and the same access point 1, identified by its MAC address, is, for example, as follows:

1. if the two lists are not identical, then:
1a. if the list L1 received from a sensor 4 comprises one or more additional clients 5 compared to the list L2 received from the access point 1, then the analyzer 3 deduces from this that there is a spoofing of the identity of this access point. In practice, this means that the additional clients found by the sensor are not associated with the legitimate access point, but with an access point 8 having spoofed the identity of the legitimate access point. The analyzer 3 then triggers an alarm to warn the administrator. It can also itself process the triggered alarm by automatically performing an action predefined by the administrator;
1b. if the list L1 received from a sensor 4 comprises one or more clients 5 that are missing from the list L2 received from the access point 1, then the analyzer concludes from this that there is nothing to report. This would be due to the fact:
   1b1. that the clients concerned have disconnected from the access point in the time interval between the moment when the list L2 was sent by the access point and the moment when the list L1 was sent by the sensor 4; or
   1b2. that the sensor 4 has not seen certain frames, so that its list of clients identified as associated is shorter than the list L2 of clients actually associated. Such is the case that we seek to avoid by multiplying the techniques for identifying the association of a client 5 with an access point 1;
      2. otherwise, the lists L1 and L2 are identical and there is nothing to report.

When such a detection process is applied, the detection program executed in the analyzer 3 conforms, for example, to FIG. 5.

The method according to the invention supplies results so much better that there is no loss of frames on the radio channel.

For the detection of association of clients 5 by the sensor 4, two techniques have been described: capturing “association success” frames and capturing IEEE 802.11 data frames (with the use of a threshold N). The loss can affect the capture of the “association success” frames. However, conversely, given that the IEEE 802.11 data frames are redundant, the use of a threshold N (for the number of IEEE 802.11 data frames sent by an access point 1 to a client 5) can make it possible to correctly identify the associated clients, so that the notion of frame loss is no longer critical.

In the case of the detection of disassociation of clients 5 by the sensor 4, the loss can affect the disassociation or disauthentication request frames. If such is the case, the sensor 4 displays a list L1 of clients potentially longer than the access point 1, and the analyzer 3 will conclude that there has been an MAC address spoofing whereas there has been none.

To avoid these false alarms, one advantageous embodiment consists in triggering a spoofing alarm only when P successive analyses give the same result, with P being an integer equal to or greater than 2. It will normally be enough to take P=2, so that the spoofing detection cycle lasts for a duration 2.Δt. This limits the effect of the loss of frames on the radio channel.

It is worth noting that the method according to the invention makes it possible to detect equipment identity spoofing without involving an intensive frame analysis. This detection is very lightweight in terms of analysis time.

Also, this method makes it possible to detect an address spoofing instance even if the attacker 8 is remote away from the legitimate device 1, because of the way the analysis is centralized. Multiple and potentially distant sensors 4 can be used.

The embodiment that has been described can be modified in various ways without departing from the scope of the invention. The method is in particular applicable to all IEEE 802.11 or similar type wireless networks.

In terms of architecture, the analyzer 3 can, naturally, be implemented in the same machine as a sensor 4 or an access point 1. There are also widely varied ways of linking the sensors 4 to the network.

Some of these sensors 4 can be colocated with access points 1 and share some of their resources.

1. A method of detecting address spoofing in a wireless network, comprising the following steps:
capturing frames transmitted over the wireless network, having an address field that comprises an address of a network access point;
analyzing the captured frames to establish a first list of stations associated with said access point;
obtaining from said access point a second list of stations that are associated with it; and
comparing the first and second lists of stations.

2. The method as claimed in claim 1, wherein an alarm is triggered if the first list includes at least one station that is absent from the second list.

3. The method as claimed in claim 1, wherein the obtaining and the comparing of the first and second lists are repeated regularly, and an alarm is triggered if P consecutive comparisons show that the first list includes at least one station that is absent from the second list, P being a number at least equal to two.

4. The method as claimed in claim 1, wherein the captured frames comprise management frames confirming the association of stations with the access point and management frames terminating the association of stations with said access point.

5. The method as claimed in claim 1, wherein the captured frames comprise data frames having the address of said access point in a source address field, and the associated stations of the first list (L1) are identified from a destination address field of said data frames.

6. The method as claimed in claim 5, wherein a station is included in the first list only once its address has been noted at least N times in the destination address field of data frames having the address of said access point in the source address field, N being a predefined threshold value.

7. The method as claimed in claim 1, wherein the captured frames comprise data frames having the address of said access point in a destination address field, and the associated stations of the first list are identified from a source address field of said data frames.

8. The method as claimed in claim 7, wherein a station is included in the first list only once its address has been noted at least N times in the source address field of data frames having the address of said access point in the destination address field, N being a predefined threshold value.

9. The method as claimed in claim 1, wherein a number of sensors are deployed in a coverage area of the wireless network to capture said frames and establish the first lists relative to at least one access point, and wherein each first established list is compared to the second list obtained from said access point to detect an address spoofing in the network.

10. A device for detecting address spoofing in a wireless network, comprising:
means for receiving from at least one sensor identification information originating from frames captured by said sensor on the wireless network, the captured frames having an address field that comprises an address of a network access point, said received identification information corresponding to a first list of stations associated with said access point;
means for obtaining from said access point a second list of stations associated with said access point; and
means for comparing the first and second lists of stations.

11. The device for detecting address spoofing as claimed in claim 10, also comprising:
means of analyzing the identification information received from the sensor, to establish the first list.

12. The device for detecting address spoofing as claimed in claim 10, wherein the identification information received from the sensor comprises the first list.

13. A system for detecting address spoofing in a wireless network, comprising:
a device for detecting address spoofing as claimed in claim 10, and
a sensor comprising
means for capturing frames transmitted over the wireless network, having an address field that comprises an address of a network access point, and
means of transmitting, to the device for detecting address spoofing, identification information relating to the stations associated with said access point, said identification information originating from the captured frames,
the sensor being arranged to recommence at zero establishing new identification information relating to the stations associated with the access point, after having transmitted the preceding identification information.

14. A computer program to be installed in a device interfaced with at least one access point of a wireless network and with a sensor to help in detecting address spoofing in the wireless network, to be run by a processing unit of said device, the program comprising instructions for executing the following steps when the program is run by said processing unit:
receiving from the sensor identification information originating from the frames captured by the sensor on the wireless network, the captured frames having an address field that comprises an address of the access point, said received identification information corresponding to a first list of stations associated with said access point;
obtaining from said access point a second list of stations that are associated with it; and
comparing the first and second lists of stations.

15. A system for detecting address spoofing in a wireless network, comprising:
a device for detecting address spoofing as claimed in claim 11, and
a sensor comprising
means for capturing frames transmitted over the wireless network, having an address field that comprises an address of a network access point, and
means of transmitting, to the device for detecting address spoofing, identification information relating to the stations associated with said access point, said identification information originating from the captured frames,
the sensor being arranged to recommence at zero establishing new identification information relating to the stations associated with the access point, after having transmitted the preceding identification information.

16. A system for detecting address spoofing in a wireless network, comprising:
a device for detecting address spoofing as claimed in claim 12, and
a sensor comprising
means for capturing frames transmitted over the wireless network, having an address field that comprises an address of a network access point, and
means of transmitting, to the device for detecting address spoofing, identification information relating to the stations associated with said access point, said identification information originating from the captured frames,
the sensor being arranged to recommence at zero establishing new identification information relating to the stations associated with the access point, after having transmitted the preceding identification information.
